(19) United States
(12) Patent Application Publication
(10) Pub. No.: US 2026/0117875 A1
(43) Pub. Date: Apr. 30, 2026

(54) COMPACT HYBRID TRIPLE SEAL FOR REVERSIBLE GATE VALVE AND METHOD

(71) Applicant: WORLDWIDE OILFIELD MACHINE, INC., Houston, TX (US)

(72) Inventor: Sudhir Shrivallabh Puranik, PUNE (IN)

(21) Appl. No.: 19/257,361

(22) Filed: Jul. 1, 2025

Related U.S. Application Data
(60) Provisional application No. 63/711,612, filed on Oct. 24, 2024.

(51) Int. Cl. F16K 3/02

(52) U.S. Cl. CPC F16K 3/0227; F16K 3/0254

(57) ABSTRACT

The present invention provides a method to produce a triple seal in a reversible gate valve utilizing only two seals that seal between the seat and the valve body on each of two seats in the gate. The method utilizes a hybrid seal configuration with only one U-shaped seal and one O-ring on each seat. The U-shaped seal on each seat is the primary seal, which is an upstream seal. Should the primary seal leak then the O-ring forms a secondary upstream seal. Should the secondary upstream seal leak then the valve is constructed so that the O-ring on the downstream seat creates a downstream tertiary seal. Since the seal configuration on each seat is the same, the valve is reversible. In other words, regardless of orientation of the valve with respect to upstream and downstream, the method of the present invention produces a gate valve with a triple seal.

### BACKGROUND

The present invention relates generally to valve assemblies and, more particularly, to an improved gate valve assembly with a triple seal seat configuration.

Gate valves are widely used in the oilfield and typically comprise an internal sliding gate that controls fluid flow through the throughbore of the gate valve. Conventional sliding gates are flat with an opening side and a blank sealing side. When the opening side of the gate is aligned with the throughbore, fluid is able to flow through the gate valve. Conversely, when the blank sealing side of the gate is aligned with the throughbore, fluid flow is prevented.

Current gate valve designs often present challenges with respect to robust and reliable sealing across varying pressures and temperatures, particularly in bi-directional flow applications. Furthermore, limitations in seal configurations can lead to increased maintenance and reduced lifespan.

Existing gate valve assemblies frequently encounter limitations in achieving consistent and robust fluid sealing across the wide range of operational pressures, temperatures, and fluid compositions common in oilfield applications. Conventional sealing mechanisms, often relying exclusively on elastomeric components, are susceptible to degradation, leading to increased maintenance requirements, reduced operational lifespan, and potential fluid leakage. Moreover, the necessity for specific valve configurations tailored to various flow directions (e.g., unidirectional versus bidirectional) and environmental parameters contributes to a complex and extensive inventory of distinct valve models. This proliferation of models hinders manufacturing standardization, increases production costs, and prolongs delivery times, thereby impacting operational efficiency and economic viability. The present invention addresses these deficiencies by providing an improved gate valve assembly with enhanced sealing capabilities, reduced complexity, and expanded operational flexibility, with particular emphasis on a novel triple seal seat configuration.

### SUMMARY OF THE INVENTION

An objective of the present invention is to provide an improved gate valve assembly.

Another objective of the present invention is to provide a method for providing a hybrid triple seal seat utilizing only two seals on each of two seats in a gate valve.

Yet another object of the present invention is to provide upstream and/or downstream sealing with identical seal configuration on each seat.

Yet another object of the present invention is to provide a gate valve that is reversible so that regardless of orientation, three seals are provided.

In accordance with the invention, a method is provided for creating a robust hybrid triple-seal seat arrangement for a bidirectional gate valve. The method may include providing a gate within the gate valve that is movable between a closed position, where the gate blocks fluid flow through the throughbore, and an open position, where the gate allows fluid flow through the throughbore. The method also includes providing an upstream seat and a downstream seat. Each of the upstream seat and the downstream seat includes a pocket end and a metal-to-metal gate seal end. The method further includes providing a first outwardly extending flange and a second outwardly extending flange on each of the upstream seat and the downstream seat, with the first outwardly extending flange being closer to the pocket end than the second outwardly extending flange on each of the upstream seat and the downstream seat.

The method also includes mounting only one unidirectional seal on each of the upstream seat and the downstream seat between the first outwardly extending flange and the pocket end. Additionally, the method includes mounting only one bidirectional seal on each of the upstream seat and the downstream seat between the first outwardly extending flange and the second outwardly extending flange on each of the upstream seat and the downstream seat.

When the gate is in the closed position, the unidirectional seal on the upstream seat provides a first seal against upstream pressure, the bidirectional seal on the upstream seat provides a second seal against upstream pressure in case the first seal leaks, and the bidirectional seal on the downstream seat provides a third seal against upstream pressure in case the first and second seals leak. The method may also include providing a gate valve body and a bonnet mounted to the gate valve body, where the bonnet defines a bonnet cavity therein. The third seal against upstream pressure receives the upstream pressure through the bonnet cavity when the first seal and the second seal leak.

The method may further include orienting an opening on the unidirectional seal on each of the upstream seat and the downstream seat toward the pocket end on each of the upstream seat and the downstream seat. The first outwardly extending flange and the second outwardly extending flange on the upstream seat may be of monolithic construction with respect to the seat, and the first outwardly extending flange and the second outwardly extending flange on the downstream seat may also be of monolithic construction with respect to the downstream seat. In other words, instead of a metal ring mounted in a groove, the ring is machined out of one-piece to form the seat with two flanges extending outwardly from the seat.

The unidirectional seal on each of the upstream seat and the downstream seat may include a U-shaped seal, with the opening of the U-shaped seal oriented away from the gate. The method may also include a hat ring that extends into the opening on the unidirectional seal on each of the upstream seat and the downstream seat. Additionally, the method may include a support ring on the non-opening side of the unidirectional seal on each of the upstream seat and the downstream seat. The method may further include a support ring on each side of the bidirectional seal on each of the upstream seat and the downstream seat. The gate valve is reversible, allowing flexibility in installation and operation so that either seat may be the upstream or downstream seat without affecting operation. It will be appreciated that gate valve may be connected to pipes without concern or orientation.

One general aspect includes a method to provide triple seal seats in a bi-directional gate valve with a throughbore. The method also includes providing a gate within the gate valve with a closed position where the gate is positioned to block fluid flow through the throughbore an open position where the gate is positioned to allow fluid flow through the throughbore, providing an upstream seat (on the upstream side of the gate) and a downstream seat (on the downstream side of the gate). The method also includes utilizing a first unidirectional seal (such as a U-shaped seal) as a first seal on the upstream seat (on the upstream side of the gate). The method also includes providing a first bi-directional seal (such as an O-ring) as a second seal on the upstream seat that receives leaked pressure if the gate valve is in the closed position and the first seal leaks. The method also includes providing a second bi-directional (such as an O-ring) as a third seal on a downstream seat (on the downstream side of the gate) being arranged so that if the first seal leaks and the second seal leaks and the gate valve is in the closed position then the third seal receives the leaked pressure.

Implementations may include one or more of the following features. The method may include providing that the gate moves axially within a body cavity between the closed position and the open position, and providing that if the first seal leaks and the second seal leaks and the gate valve is in the closed position then the third seal receives the leaked pressure through the body cavity. The method may include providing a pocket end and a metal to metal gate seal end on each of the upstream seat and the downstream seat, providing two outwardly extending flanges on each of the upstream seat and the downstream seat, and providing the second seal and the third seal between the two outwardly extending flanges on respective of the upstream seat and the downstream seat. The method may include mounting the first seal between one of the two outwardly extending flanges and the pocket end on the upstream seat. The method may include providing a second unidirectional seal as a fourth seal between one of the two outwardly extending flanges on the pocket end of the downstream seat. The method may include orienting an opening on the first unidirectional seal away from the gate and orienting an opening on the second unidirectional seal away from the gate where the gate valve is reversible (either seat could be the upstream seat or the downstream seat). The two outwardly extending flanges extend outwardly from the sealing surface on the upstream seat for the first seal and the sealing surface on the upstream seat for the second seal. The method may include providing that the sealing surface on the upstream seat for the first seal and the sealing surface on the upstream seat for the second seal are each at equal radial distances from an inner surface of the upstream seat. The method may include providing that the upstream seat may include the two outwardly extending flanges of one-piece (or monolithic) construction. The method may include providing that the sealing surface on the upstream seat for the first seal is a step (a surface with only one wall formed by one of the two outwardly extending flanges) and the sealing surface on the upstream seat for the second seal is a groove formed between two outwardly extending flanges. The method may include providing that an outer surface of each of the two outwardly extending flanges are each at equal radial distances from an inner surface of the upstream seat.

The method may include providing that the first bi-directional seal is used for sealing between the upstream seat and the valve body of the bi-directional gate valve, and where the first bidirectional seal is the only bidirectional seal used for sealing between the upstream seat and the valve body of the bidirectional gate valve. The second bidirectional seal is the only bidirectional seal used for sealing between the downstream seat and the valve body of the bidirectional gate valve. The second unidirectional seal is the only unidirectional seal used for sealing between the downstream seat and the valve body of the bidirectional gate valve. The first unidirectional seal and second unidirectional seal may include U-shaped seals with an opening of the U-shaped seals each being oriented away from the gate, the first and second bi-directional seals being between the gate and the first and second first and second unidirectional seals.

A method for providing triple seal seats in a bi-directional gate valve with a throughbore is disclosed. The valve includes a gate movable between a closed position, blocking flow through the throughbore, and an open position, allowing flow. Upstream and downstream seats are provided, each with a triple seal configuration.

The upstream seat includes:

A first unidirectional seal (e.g., a U-shaped seal) on the upstream side of the gate.

A first bi-directional seal (e.g., an O-ring) positioned to receive leaked pressure if the first seal leaks when the gate is closed.

The downstream seat includes:

A second bi-directional seal (e.g., an O-ring) positioned to receive leaked pressure if both the first and second seals on the upstream seat leak when the gate is closed.

Implementations may include the following features:

The gate moves axially within a body cavity between open and closed positions. Leakage through the upstream seals is directed to the downstream seal via the body cavity.

Each seat may have a pocket end and a metal-to-metal gate seal end, along with two outwardly extending flanges. The bi-directional seals are positioned between these flanges.

The first unidirectional seal on the upstream seat is mounted between a flange and the pocket end.

A second unidirectional seal may be provided on the downstream seat between a flange and the pocket end, with its opening oriented away from the gate, similar to the upstream unidirectional seal. This configuration is advantageous to provide a reversible gate valve due to use of the same sealing configuration on both seats.

The flanges on each seat extend outwardly from the sealing surfaces for the first and second seals. These sealing surfaces may be equidistant from the inner surface of the seat.

The flanges on each seat may be of one-piece (monolithic) construction.

On the upstream seat, the sealing surface for the first seal may be a step, while the sealing surface for the second seal is a groove formed between the flanges. The outer surfaces of the flanges may be equidistant from the inner surface of the seat.

The first bi-directional seal is the only bi-directional seal between the upstream seat and the valve body. Similarly, the second bi-directional seal is the only bi-directional seal between the downstream seat and the valve body. The second unidirectional seal is the only unidirectional seal between the downstream seat and the valve body.

The U-shaped seals have their openings oriented away from the gate. The bi-directional seals are positioned between the gate and the respective unidirectional seals.

In a further aspect, a gate valve assembly is provided comprising: a valve body defining a throughbore; a gate movable within the valve body between an open position and a closed position; and an upstream seat and a downstream seat, each seat configured to engage the gate. Each seat further comprises: a metal-to-metal sealing end configured to engage the gate; a pocket end for mounting within a corresponding pocket of the valve body; a first monolithic outwardly extending flange and a second monolithic outwardly extending flange; a single unidirectional seal positioned between the first outwardly extending flange and the pocket end, wherein an opening of the unidirectional seal is oriented towards the pocket end; and a single bidirectional seal positioned between the first outwardly extending flange and the second outwardly extending flange. The arrangement ensures a triple seal against fluid pressure when the gate is in the closed position, regardless of the valve's installation orientation.

### BRIEF DESCRIPTION OF THE DRAWINGS

The following detailed description and claims are merely illustrative of the generic invention. Additional modes, advantages, and particulars of this invention will be readily suggested to those skilled in the art without departing from the spirit and scope of the invention. A more complete understanding of the invention and many of the attendant advantages thereto will be readily appreciated by reference to the following detailed description when considered in conjunction with the accompanying drawings, wherein like reference numerals refer to like parts and wherein:

FIG. 1 is a perspective view of a gate valve with a rectangular lower body cavity and a round upper body cavity in accord with one embodiment of the present invention;

FIG. 2 is a side elevational view of a gate valve without the bonnet and showing a rectangular body cavity without a round body cavity in accord with one embodiment of the present invention;

FIG. 3 is a top view looking down the body cavity through a generally circular upper body cavity to a lower rectangular body cavity for a gate valve assembly in accord with one embodiment of the present invention;

FIG. 4 is a side sectional view of a gate valve assembly showing slimmer seats on the side of the gate within the rectangular body cavity than is possible with a round body cavity in accord with one embodiment of the present invention;

FIG. 5 is a side view of a gate valve showing two seats and seal assemblies on either side of the gate in a rectangular portion of the body cavity in accord with one embodiment of the present invention;

FIG. 6 is a side view of a possible seal assembly on one of the two seats of a gate valve assembly in accord with one embodiment of the present invention.

FIG. 7 is an exploded perspective view for one embodiment of a seat with seal assembly for a gate valve in accord with one embodiment of the present invention.

FIG. 8 is a side view of another possible seal assembly on one seat of a gate valve in accord with one embodiment of the present invention.

FIG. 9 is a perspective view of a T-slot connector gate that slidingly fits onto a T-shaped stem connector for a gate valve in accord with one embodiment of the present invention.

FIG. 10 is a perspective view of a skirt assembly to prevent or limit debris from entering the body cavity for a gate valve in accord with one embodiment of the present invention.

FIG. 11 is a partial sectional perspective view of a skirt assembly inserted into the round and rectangular portions of the body cavity to prevent debris from entering the body cavity when opening and closing the gate for a gate valve in accord with on embodiment of the present invention.

FIG. 12 is a cross-sectional view of the skirt assembly inserted into round and rectangular portions of the body cavity of a gate valve in accord with one embodiment of the present invention.

FIG. 13 is a cross-sectional view of a 7 1/16 inch triple seal seat for use in a gate valve to control pressures up to 15,000 psi in accord with the invention.

FIG. 14 is a front elevational view of a 7 1/16 inch triple seal seat for use in a gate valve to control pressures up to 15,000 psi in accord with the invention.

FIG. 15 is a perspective view of a 7 1/16 inch triple seal seat for use in a gate valve to control pressures up to 15,000 psi in accord with the invention.

FIG. 16 is a detail view of a region of FIG. 13 in accord with the present invention.

FIG. 17 is a cross-sectional view of a pair of 7 1/16 inch triple seat seals oriented as they would be within the gate valve cavity of a gate valve body in accord with the invention.

FIG. 18 is a perspective view of a pair of 7 1/16 inch triple seat seals oriented as they would be within the gate valve cavity of a gate valve body in accord with the invention.

FIG. 19 is a side view of a 7 1/16 inch triple seal seat for use in a gate valve to control pressures up to 15,000 psi in accord with the invention.

FIG. 20 is a front elevational view of a 3 1/16 inch triple seal seat for use in a gate valve to control pressures up to 20,000 psi in accord with the invention.

FIG. 21 is a cross-sectional view of a 7 1/16 inch triple seal seat for use in a gate valve to control pressures up to 15,000 psi in accord with the invention.

FIG. 22 is a perspective view of a 3 1/16 inch triple seal seat for use in a gate valve to control pressures up to 20,000 psi in accord with the invention.

FIG. 23 is a perspective view of a pair of 3 1/16 inch seats for use with triple seals in accord with the present invention.

FIG. 24 is an elevational view in cross-section showing a pair of 3 1/16 inch seats with a seal configuration that produces a triple seal in accord with the present invention.

FIG. 25 is a side elevational view showing a seat for use in producing a triple seal in accord with the present invention.

### DETAILED DESCRIPTION

Detailed descriptions of the invention are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

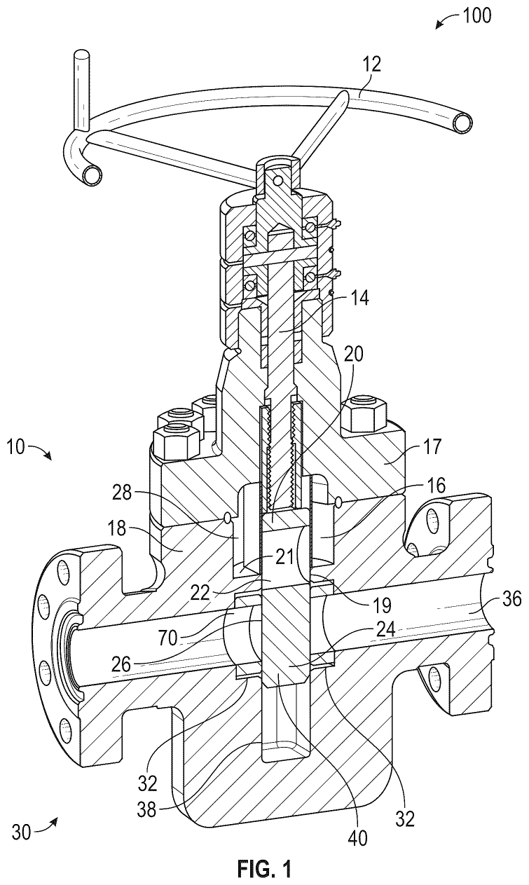

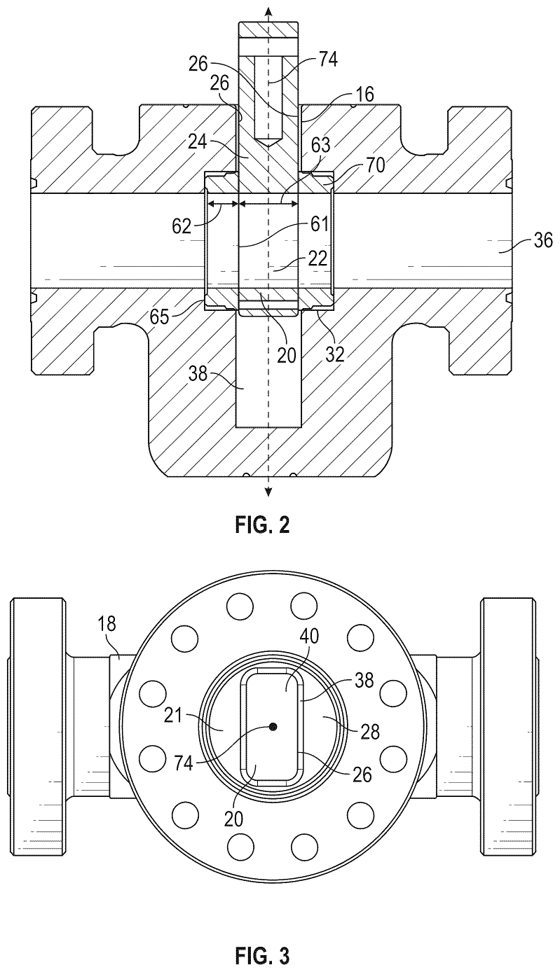

Referring now to the drawings, and more particularly to FIG. 1, a gate valve 100 is shown comprising a valve body 18. Internal to valve body 18 is a body cavity 16, which includes a generally circular cross-section upper body cavity 28 and a rectangular cross-section lower body cavity 38. Throughbore 36, also of circular cross-section, extends through the gate valve 100 perpendicular to the body cavity 16. Bonnet 17 also defines a portion of the generally circular upper body cavity 28. A floor 21 is the bottom of the round body cavity 28 and the beginning of rectangular body cavity 38 and includes a rectangular throat portion 19 of body cavity 16 above throughbore 36. More specifically, just above throughbore 36, there is a first rectangular cross-section portion of the body cavity. While from floor 21 upwards as shown in the drawing, the body cavity 16 is generally circular. Also, while the entire upper body cavity 28 could be rectangular as shown in FIG. 2, it has been found advantageous that upper body cavity 28 is generally circular as discussed hereinafter. The round body cavity may be either generally circular so as to be circular or elliptical or have overall rounded portions circularly arranged.

The gate 20 comprises flat sides 26 which are in contact with the body cavity 16 and seats 70. In one possible embodiment, the gate 20 has an opening 22 on the upper portion of the gate. The opening 22 when aligned with the throughbore 36 is the open position of the gate valve 100 and allows fluid flow through the throughbore 36. A blank sealing surface 24 is on the opposite side of the gate 20 from the opening 22 blocks fluid flow and seals the throughbore 36 when aligned with the throughbore 36.

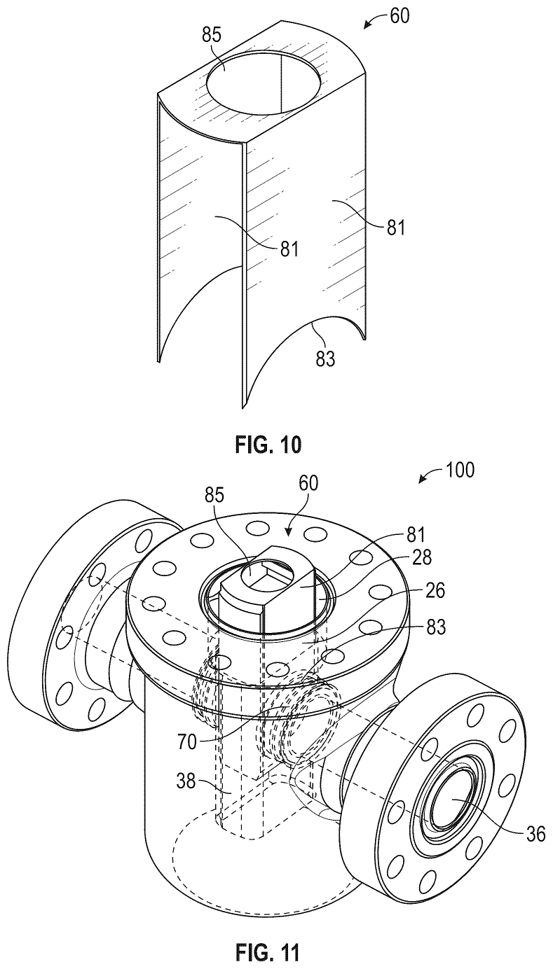

Gate 20 is provided with a round opening 22 the same size as throughbore 36 which allows fluid flow through the gate in an open position and stops fluid flow when in the closed position. In a preferred embodiment, this opening is located in an upper portion of the gate 20, when the gate is oriented upright as shown in the figures. One benefit of having the opening 22 at the top of the throughbore is the use of skirt 60 that reduces the amount of debris that enters body cavity 16. See FIGS. 10-12 that show skirt 60 surrounding the gate 20 in sliding engagement with the gate that prevents debris from collecting in or moving around the body cavity 16 during movement between the open to the closed position. Another practical benefit of having the opening at the top allows simplification across all gate valve sizes with reduced numbers of different parts required. This standardization to reduce the number of parts needed for different size gate valves lowers stock requirements and the time required to manufacture a gate valve for a desired application, i.e. 2 in gate valve, 4 in gate valve, or 5 in gate valve for a particular environment.

Seats 70 are positioned between the gate 20 and the valve body 18 on both sides of the gate 20. The gate engages the metal seats 70 to provide a metal to metal seal with the seats. The metal to metal seal operates over the wide range of temperature, pressure, and types of fluids that are encountered in oilfield operations. Leakage around seats 70 between the seats and the valve body 18 in pockets 32 is discussed hereinafter.

Gate valve 100 may be operated manually by use of a handle 12 which is rotated. However, a powered operator may also be utilized. In this case, handle 12 is connected to a valve stem 14 which rotates to raise or lower gate 20.

In more detail and continuing the discussion above, the body cavity 16 may be divided into two portions, an upper round or upper generally circular cavity side 28 above floor 21 and a lower rectangular cavity side 38 below floor 21. The upper body cavity 28 may have a circular cross-section, oval cross-section, elliptical cross-section, or the like. While an oval cross-section may reduce the body size, number of bolts, and the like to maximize weight/size reduction it may be easier to manufacture using a circular cross-section body cavity.

An advantage of a generally circular cross-section in upper body cavity 28 over a rectangular cross-section is that upper body cavity 28 may be better packed with grease or other suitable lubricants to ease movement and sealing of the gate within the cavity. It will be appreciated that due to the larger size of the upper generally circular body cavity 28 as compared to a rectangular upper body cavity, more grease may be utilized, which provides more lubrication and blocks debris from the fluid flow through throughbore 36. During opening and closing of the gate debris can make its way into the body cavity 16 due to accumulation in gate opening 22.

The gate 20 has a rectangular cross-section that fits snugly with the rectangular cross-section of lower body cavity 38. A view of the rectangular cross-section of the lower body cavity 38 is visible looking down into the valve (with the bonnet removed) from the top as shown in FIG. 3. A rectangular cross-section body cavity 38, which may also be referred to as a second rectangular cross-section portion, reduces the amount of material needed to construct the gate valve for the given size throughbore 36 and thereby reduces the weight. Another advantage of the rectangular body cavity is that it reduces the seat width 62 (see FIG. 2) required for the seats 70 because they do not have to be wide enough to extend through the radius of a circular body cavity before reaching the pocket 32 into which the seats 70 fit. This can also allow for a narrower gate 20 as discussed hereinafter.

Lower side 30 of the gate valve comprises the rectangular body cavity 38. As explained above, the use of a rectangular body cavity allows for the smaller seat width 62 (and weight) seats to be utilized and for a narrower gate. The seats may have a reduced seat width 62 (FIG. 2) extending outward from the gate and compared to the gate width 63 (FIG. 2). This in turn reduces the amount of materials needed, the costs required for construction, and reduces the overall weight of the gate valve.

Turning to FIG. 2, a side elevational view of gate valve 100 is shown in accord with one embodiment of the present invention. An axis 74 through the body cavity 16 is perpendicular to throughbore 36 and bisects body cavity 16. During opening and closing operation, gate 20 moves axially along axis 74. Axis 74 also bisects gate 20. In FIG. 2, gate 20 is axially positioned such that opening 22 is aligned with throughbore 36 thereby allowing fluid to flow through throughbore 36.

The seat width 62 is the distance between the sealing end 61 and the outer end 65 of each seat. In prior art systems, a rounded cavity is commonly used with the flat gate which in turn requires wider seats. In one embodiment, the gate width 63 between the two flat sealing sides 26 of gate 20 is greater than the seat width 62 between said sealing end 61 and the outer end 65 of each seat. Accordingly, the use of a rectangular body cavity provides the advantage of decreasing the amount of material necessary to make the enlarged size of a rounded body cavity, reducing weight, and size of the valve for the same size throughbore 36 and pressure rating of the gate valve. The weight of valve body 18 may be reduced by approximately 32% in this manner. In other possible embodiments, the amount of weight reduced may be more or less than 32% as well.

As one example, a prior art round body cavity required a seat width of approx. 5.5 inches and a gate width of 4.5 inches for a valve with throughbore 36 diameter of 3 1/16 inches and 15K pressure rating. In the new design for the same size throughbore 36 with a rectangular body cavity, the gate could have a thickness 63 of 2.62 inches and the seat a thickness 62 of 1.6 inches. In this example the seat width is 62% of the gate width. Accordingly, the seat width is less than 100%, or less than 90%, or less than 80%, or less than 70%, or could be any percentage in this range, of the gate width. This saves not only the weight of the body but also reduces the weight of the gate and seat considerably. The gate has a thickness 63 less than the diameter of throughbore 36 and in this example is 85% of the throughbore or less than 90% of the throughbore.

FIG. 3 shows a top view of a gate valve body 18 for a gate valve assembly 100 looking down into body cavity 16 in accord with one embodiment of the present invention. The generally circular cavity 28 portion of body cavity 16 is formed within an upper portion of body 18 that bottoms at floor 21. Gate 20 is located within circular cavity 28 and rectangular body cavity 38. Gate 20 is rectangular with a rectangular cross section 40 perpendicular to axis 74. Gate 20 is comprised of flat sealing sides 26 that engage the seats (see FIGS. 1 and 2). The rectangular gate 20 fits snugly into the rectangular body cavity 38. The circular cavity 28 may also be packed with grease or other suitable lubricants allowing for smoother operation and less wear during movement of the gate within the body cavity while the gate moves from the open or closed positions. As noted above, having the upper body cavity being round allows for more grease than if the body cavity were also rectangular at the top of the valve. However, having a rectangular body cavity at the top of the valve would also be a possible design in accord with the present invention.

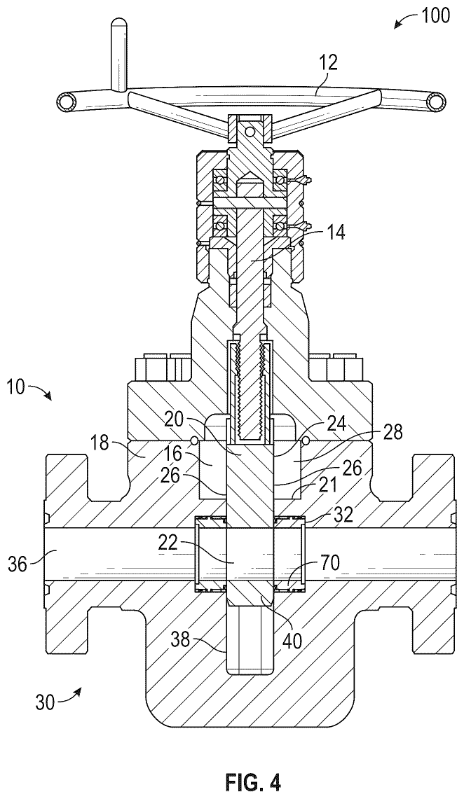

Turning to FIG. 4, a side sectional view of gate valve 100 is shown in accord with one embodiment of the present invention. The body cavity 16 has a lower body cavity portion or rectangular body cavity 38 which is rectangularly shaped below the throughbore 36 on a second or lower side 30 of the gate valve. An upper body cavity portion of body cavity 16 comprises a generally circular cavity 28 above floor 21 on a first or upper side 10 of the gate valve. In other embodiments, the upper body cavity portion may be oval or rectangular shaped.

In one embodiment, the lower portion of the body cavity on lower side 30 of the gate valve slidingly receives the rectangular gate 20 when the gate valve 100 is moved into the open position. In another possible embodiment, the gate 20 may have the opening 22 on the lower part of the gate with the blank on the upper side of the gate 20. As shown, the gate 20 is in the open position with opening 22 aligned with throughbore 36 thereby allowing fluid to flow. When desired or necessary, gate 20 may be lowered by turning handle 12 which is connected to stem 14 and further connected to the gate 20. The rectangular gate 20 will then move axially into rectangular cavity 38. It will also be appreciated that the seats 70 have a decreased width. The rectangular body cavity shape brings the seats 70 closer to the gate 20 and eliminates the need for seat retainers, which are used in some prior art gate valves. Eliminating the need for seat retainers to keep the seats in position within pockets 32 with respect to gate 20 further reduces the stock requirements and time constraints to manufacture a gate valve consistent with the present invention.

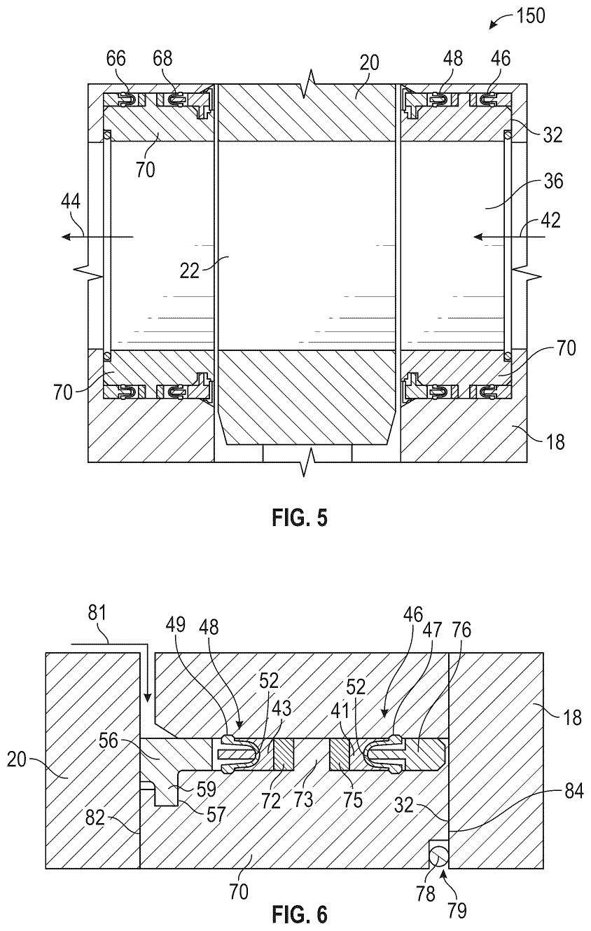

In FIG. 5, a side view of a seat assembly 150 is shown in accord with one embodiment of the present invention. As shown, gate 20 is in the open position with opening 22 aligned with throughbore 36. The seats 70 are mounted in pockets 32 in body 18. The upstream side is indicated by flow arrow 42 while the downstream side is indicated by flow arrow 44. When the gate 20 is moved to the closed position, the fluid flow in throughbore 36 is blocked by the flat sides of blank section 24 of gate 20 (see FIG. 1). The upstream seals 48, 46 and downstream seals 66 and 68 prevent fluid flow around the seats 70 between the seats and the valve body 18. However, only one upstream and one downstream seal are used for each flow direction.

For example, if the valve is closed then upstream seal 46 prevents fluid flow between the upstream seat and the body 18. If seal 46 fails, is inoperable, or is not installed, then fluid may flow past seal 48, around the upstream seat and around the gate 20 but is sealed off by downstream seal 68. In other words, the U-shaped upstream seal 48 and downstream U-shaped seal 68, which have their open end pointing towards the upstream flow block fluid flow as indicated by flow arrow 42. The use of two seals provides the benefit of greater sealing ability because of redundancy in the event the upstream seal does not stop fluid flow. In other words, if upstream seal 46 prevents fluid flow around upstream seat 70, then downstream seal 68 is not sealing or not at that moment used to stop the flow of fluid.

Some purchasers of valves prefer to have only bidirectional downstream sealing in the gate valve. In the above example, seals 46 and 66 are then removed so that only downstream sealing is utilized. In that way, when the valve is closed, downstream seal 68 will seal between the downstream seat and body 18 to prevent leakage past the downstream seat. If it were desired to have only bidirectional upstream sealing, then seals 48 and 68 could be used. If for some reason it were desired to have only a single direction of sealing, for example upstream sealing, then all seals except seal 46 might be removed. Thus, the seal configuration can be changed for user preference but for bidirectional redundant sealing all seals are installed. Manufacturing seat assemblies 150 in the manner described herein allows for one standardized part assembly to be produced which serves a variety of sealing needs, i.e. downstream only, upstream only, or bidirectional, without the need for different seat assemblies 150 to be manufactured for each separate desired application.

It will be appreciated that if the fluid flow is reversed, then seal 66 becomes the upstream seal and seal 48 becomes the downstream backup seal around the seats. Therefore, the valve is bidirectional and operates effectively for fluid flow in either direction. Only two seals are operational depending on the direction of fluid flow in throughbore 36. This configuration is optimal for use in varying conditions.

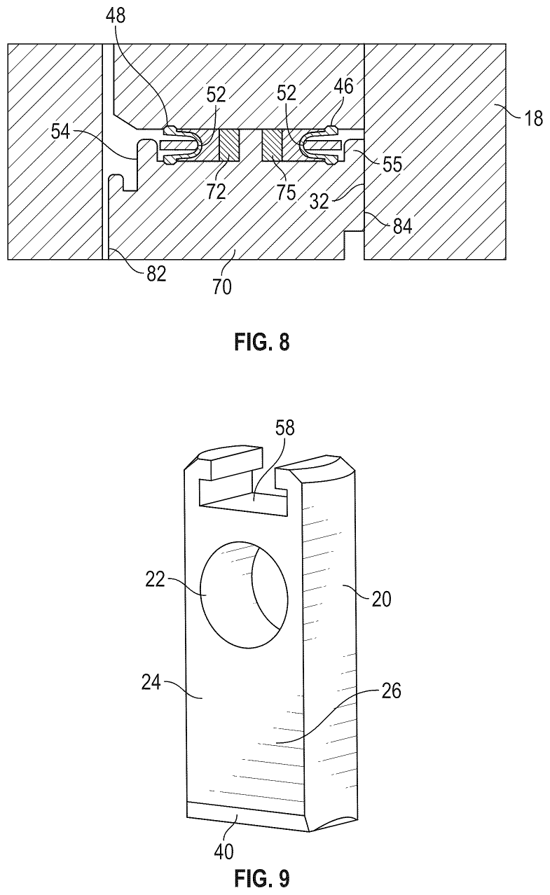

In FIG. 6 and FIG. 8, the components of the seat seals, 46 and 48 are shown in greater detail. Seat seals 66, 68 are the same construction. Each seat 70 comprises a metal seat body with a plurality of non-elastomeric seal members. In a preferred embodiment, the metal seat body of seat 70 itself is Inconel metal. The seal members comprise PTFE seals with stainless steel springs to energize the downstream seals and PEEK material support and retaining rings for both the upstream and downstream seals. By eliminating elastomeric O-rings, the gate valves will have a longer lifespan with less maintenance requirements while being able to withstand exposure to more extreme conditions. The temperature range of operation is then −50 degrees to 350 degrees F. The seal members are good for all or practically all fluids including corrosive and acidic fluids that will be encountered in the oilfield. Further the seals are good for all pressures up to 20,000 psi. As well, this material lasts a long time. Thus, the problems associated with choosing the correct O-ring for the pressures, fluids, and temperatures to be encountered is eliminated. As well, the problem of replacing seals on a regular basis due to age is eliminated.

Turning again to FIG. 6, an enlarged side view of a seat 70 is shown in accord with one embodiment of the present invention. If fluid attempts to flow behind seat 70 as indicated by arrow 79, then seal 46 prevents the fluid flow. This would be the situation discussed in FIG. 5 with fluid flow in throughbore 36 in the direction indicated at 42.

If fluid flow were in the opposite direction than as shown in FIG. 5, and has leaked through the upstream seal 66, then as indicated by fluid flow arrow 81 towards the seat 70, the fluid is directed towards the seal 48, which seals around the seat.

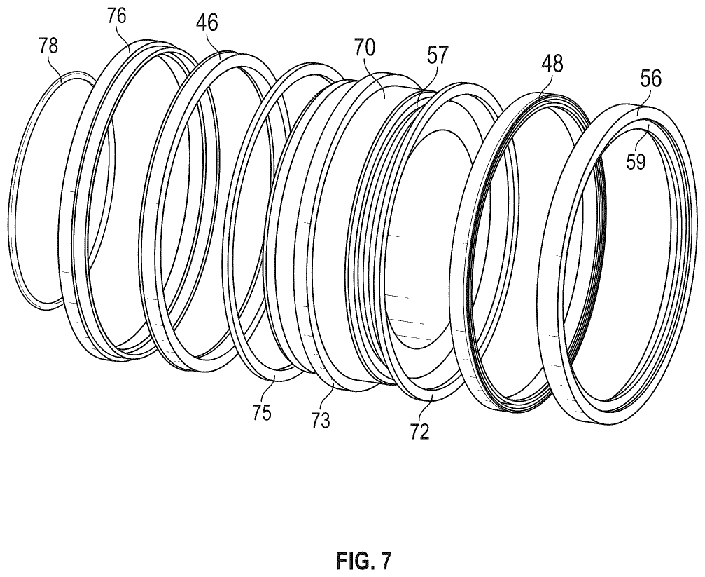

As shown perhaps better in FIG. 6 than FIG. 7, the seal assembly of U-shaped seal 48 and support ring 72 used with seat 70 on one side of metal flange 73 is held in place by retainer ring 56. Retainer rings may be non-metallic or non-elastomeric retainer rings. Retainer ring 56 is snapped or pressed into place by inserting leg 59, which extends from retainer ring 56, into slot 57. Retainer ring 56 maintains U-shaped seal 48 and support ring 72 in place against metal flange 73 of seat 70. Support ring 72 also preferably provides an anti-extrusion or non-extrusion function due to being comprised of a harder material than base regions 41 and 43 of U-shaped seals 46 and 48. Support rings may be non-elastomeric. In this embodiment, there is no need for retainer ring 76 to snap into place on the opposite side as retainer ring 56 because the valve body 18 is operable to maintain U-shaped seal 46 and corresponding support ring 75 in place. Support rings 72 and 75 are directly next to metallic flange 73 and between U-shaped seals 46 and 48. Sealing end or surface 82 of seat 70 engages one of the flat sides of gate 20 when the gate is closed to seal throughbore 36. Outer spring 78 at outer end 84 of seat 70 urges seat 70 against gate 20 to form an initial seal. The radial length of outer end 84 is greater than the radial length of sealing end 82 so that pressure between pocket wall 32 and outer end 84 produces a force pushing seat 70 towards gate 20 that keeps the seat firmly against the gate as pressure rises in throughbore 36 when the gate is closed.

As one possible example of operation, fluid flow in the direction of arrow 81 may flow pass retainer ring 56 to U-shaped seal 48 whereby the pressure of the fluid expands U-shaped seal 48 open to block the fluid from traveling beyond the seal. The actual seals 47 and 49 on the ends of leg expansion springs 52 are formed of PTFE as discussed above. Leg expansion springs 52 are utilized to retain the seal in engagement with the metal walls of pocket 32 and in the proper orientation for proper sealing. Springs 52 expand seals 47 and 49 that press against the body 18 within pocket 32 to create an initial seal. Pressure within the U-shaped seal 48 due to pressure in throughbore 36 urges the wings or legs of spring 52 open so that the seal 49 maintain the seal with higher pressures. The higher the pressure in throughbore 36, the greater the force created on seal 49 due to pressure within the U-shaped interior of the seal and thereby increases the openings of the U-shaped interior. Springs 52 may be constructed of a stainless steel or other suitable material.

Outer spring 78 is installed on the opposite side of seat 70 from gate 20 to create initial tension or pressure between the seat and gate 20 thereby creating an initial metal to metal seal between the flat side of gate 20 and the face or sealing end 82 of seat 70.

Turning to FIG. 7, an exploded perspective view of a seat 70 with sealing assembly is shown in accord with one possible embodiment of the present invention. The combination of seat 70 with the corresponding seals may be referred to as a seat assembly. As discussed above, the seat assembly is further comprised of an outer spring 78 that is utilized to press seat 70 against the gate to create an initial tension whereby an initial metal to metal seal is made between the gate surface and the metal surface of seat 70.

In one possible seal ring assembly embodiment, retainer ring 56 may be pressed into place to retain the position of the plurality of other rings and the seat into place against the valve body. Opposite retainer ring 56 is retainer ring 76. Seal rings 48 and 46 are operable to expand to stop fluid from flowing passed. The seals are operable for bidirectional sealing. These seal rings may be comprised of PTFE with stainless steel springs which aid in pressing the seals against the body for greater sealing ability. Polytetrafluoroethylene (PTFE) is a synthetic fluoropolymer of tetrafluoroethylene that has numerous applications. The use of PTFE versus prior art rubber rings allows for a greater range of temperatures, pressures, and conditions to be utilized. These seals may also be referred to as non-elastomeric seals. Non-elastomeric seals provide the advantage of lower maintenance needs and a wider temperature range than elastomers, as well as a wider range of chemical compatibility. Therefore, utilizing non-elastomeric seals will allow an operator to use one set of rings in a much wider variety of applications leading to reduced time in changing out seals, reduced maintenance costs, and increased operational flexibility. The number of components required to keep in stock for the multitude of applications is significantly reduced, as seat 70 will be able to be used in multiple applications, rather than having separate seats 70 for each different application. Anti-extrusion support rings 72, 75 and retaining rings 56 and 76 may be comprised of PEEK material. PEEK is a semicrystalline thermoplastic with excellent mechanical and chemical resistance properties that are retained to high temperatures.

In FIG. 6, outer retainer rings 56, 76, are used to form outer barriers that contain sealing rings 48, 46 on the seat 70, while in FIG. 8 the seat metal body itself comprises metallic outer barriers or lips that contain the sealing rings on seat 70.

Comparing FIG. 6 to FIG. 8, a different sealing assembly is shown. Fewer sealing rings are required because there is no need for outer seat retainer rings 56, 76 to hold the seat in arrangement with the gate. As can be seen in FIG. 8, retainer ring 56 is omitted using lip 54.

In this embodiment, U-shaped seal rings 46, 48 may be slidingly installed passed lip 54 using a cone shaped tool (not shown). In other words, the cone shaped tool has a smaller diameter onto which the U-shaped seal ring is placed and that smoothly increases in diameter to the diameter of the lip. The U-shaped seal slides along the cone shaped tool until it is compressed sufficiently to slip over the lip, such as metallic lip 54 near the sealing side or metallic lip 55 on the opposite side. If it is attempted to install the U-shaped seal ring without the tool it is very likely that the U-shaped seal will be damaged because the U portion is pressed together hard due to the lip being sized to be at the outer range of circumference that the diameter of the U-shaped seal can be slipped over without damage.

Lip 54 protrudes into the channel or gap to allow the seals to be slid into place while also performing the function of the retaining ring 56 (FIG. 6) which is no longer needed. Additionally, on the opposite end relative lip 54, retaining ring 76 has been omitted. Likewise, lip 55 has been added similar to lip 54 to perform the function of the retaining ring which has been removed in this embodiment. Therefore, fewer parts are required for assembly while retaining the same functionality.

In FIG. 9, a perspective view is shown of a gate for a gate valve in accord with one embodiment of the present invention. In one possible embodiment, gate 20 is generally rectangular comprising flat sides 26 and rectangular cross section 40 as discussed previously. Gate 20 has an opening 22 and a blank sealing region 24 which when aligned with the throughbore will either provide sealing or allow the flow of fluid through the throughbore. As discussed above, the seats make a metal-to-metal seal with the blank sealing region 24. When the gate is oriented vertically, a T-slot which may also referred to as a stem connector, gate connector, stem-gate connection, or latch 58 may be positioned at the top. The connector 58 may be milled or forged into the gate 20. The connector 58 also has a reciprocal connector on the stem to be inserted into the connector 58. The T-slot 58 may be a non-threaded latch to allow the stem to be slid or pressed into the connection on the gate 20. This type of connector may provide added strength and rigidity to the gate and connection between the gate and the stem and additionally decreased time may be required to assemble the gate valve.

Turning to FIGS. 10-12, various views of a skirt assembly for gate valve 100 are shown in accord with one embodiment of the present invention. Skirt 60 covers the opening 22 of the gate 20 when the gate is closed. In this way, skirt 60 prevents dirt, debris, and the like that may be caught in opening 22 during operation from entering the body cavity 16 when the valve is closed. This prevents dirt or debris from contaminating the body cavity which may lead to clogging, impairing, or otherwise hampering the operation of the gate valve. Additionally, the use of skirt 60 ensures proper operation and increases operational time while decreasing down time required to clean and maintain the gate.

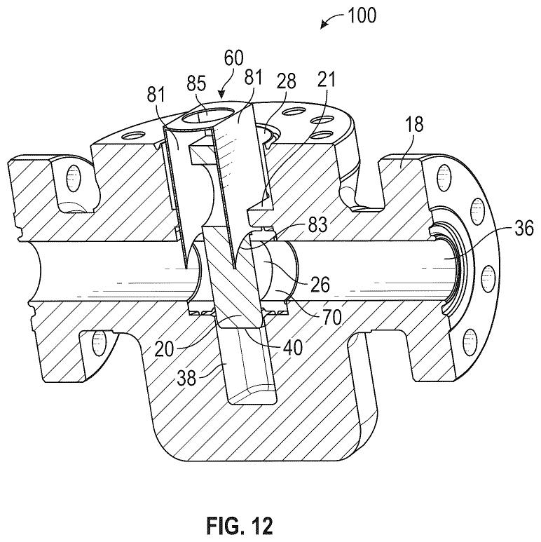

In one possible embodiment, as shown in FIG. 10, skirt 60 is constructed of a rectangular frame complementary to the gate 20. As seen in FIGS. 11-12, Skirt 60 is inserted into body cavity 16 and over gate 20 where it is fixed in place with respect to valve body 18. Skirt 60 has two sides or skirt plates 81 that slidingly engage the gate thereby sealing the cavity from contamination. Skirt 60 comprises two semicircular recesses 83 to allow close engagement with the seats 70. The skirt has a circular opening 85 at the top to allow connection of the stem and gate. Skirt 60 may be comprised of metal or other suitable material that is resilient enough to withstand the pressures and temperatures present during well operations.

In FIG. 12, it can be seen that the two sides 81 of skirt 60 extend through the generally circular or rounded cavity 28, past floor 21 of rounded cavity 28 and into engagement with the seats 70. As explained above, when the gate is opened and debris is trapped in the opening 22 of the gate, then sides 81 prevent debris from entering the body cavity. As also discussed above, the body cavity is preferably filled with grease to further prevent debris from entering the body cavity.

When comparing the prior art valves with the present invention, the gate and seats of the improved gate valve assembly are both slimmer, as the body cavity size is decreased overall. This provides advantages of decreased weight and size for a particular throughbore size, operation in a very wide range of temperature, pressure, and fluid. As well there is a limited need for maintenance as compared to prior art gate valves because the individual components are not having to be replaced as often to be compatible with the current parameters of the application.

Further, the reduced number of parts and much wider range of temperature, pressure, and fluid operation allows the same valve to be used in many different types of applications. There are 980 options when considering size, pressure rating, and material class; and 3,920 combinations when considering size, pressure, material, and temperature. However, there are at least 38,000,000,000 valve combinations that could be required depending on the bore size, pressure rating, temperature rating, material class, PSL level, PR level, 3^{rd} party requirements, API regulations, bolting requirements, overlay, work medium, surface or subsea environment, model, end connection type, operator type, indicator type, and seat skirt for a desired application. Oftentimes, multiple models with different designs are needed to be manufactured to satisfy these options. By standardizing parts based on temperature rating, material classes, PSL levels, bolting requirements, overlay, models, indicator type, and seat skirt, the present invention is able to reduce the number of possible combinations for a gate valve to be produced to under 17,000,000 This reduces engineering costs required to build each valve for specific applications and even allows the ability to keep the valves and their associated components in stock. The present invention may have the potential to reduce the number of models required to fully satisfy the desired parameters outlined above.

Currently there are 4 different temperature range options for valves based on API standards: 1) P+U (−20 degree Fahrenheit to 250 degree Fahrenheit), 2) P+X (−20 degree Fahrenheit to 350 degree Fahrenheit), 3) L+U (−50 degree Fahrenheit to 250 degree Fahrenheit), and 4) L+X (−50 degree Fahrenheit to 350 degree Fahrenheit). The present invention only uses non-elastomeric seals (See FIG. 7) which satisfy the L+X option and therefore also cover the other 3 temperature options. This eliminates 3 of the 4 previously required stock options to manufacture a gate valve.

By standardizing the material class options, which currently consist of 1.5, 360, and “No Limit” H2S partial pressures, to only the “No Limit” option for Material Classes DD through FF, the present invention removes 6 options that previously would have been required to be held in inventory, which is costly, or manufactured on demand, which is time-consuming. Further standardization of Material Classes AA through CC are consistent with the teachings herein to teach a method to reduce the stock requirements and time to manufacture a gate valve.

As discussed herein when referring to FIGS. 6 and 8, seats 70 are manufactured with Inconel. When given consideration for seat weight and wall thickness design factor, the seat geometry of seats 70 can be combined for the following valve sizes and pressure ratings: 1) 2″: one seat design for 5 KSI, 10 KSI, 15 KSI, and 20 KSI applications; 2) 3″: one seat design for 5 KSI, 10 KSI, 15 KSI, and 20 KSI applications; 3) 4″: one seat design for 5 KSI and 10 KSI, one seat design for 15 KSI and 20 KSI; 4) 5″: one seat design for 5 KSI and 10 KSI, one seat design for 15 KSI and 20 KSI.

Furthermore, the manufacture of gates for manual, hydraulic, and fail-safe closed valves can be standardized to be only Inconel and 4140 steel, with the bore on the upper portion of gate 20. Taking into account gate weight and wall thickness design factor, the gate geometry can be combined for the following valve sizes and pressure ratings: 1) 2″: one gate design for 5 KSI, 10 KSI, 15 KSI, and 20 KSI applications; 2) 3″: one gate design for 5 KSI, 10 KSI, 15 KSI, and 20 KSI applications; 3) 4″: one gate design for 5 KSI and 10 KSI, one gate design for 15 KSI and 20 KSI; 4) 5″: one gate design for 5 KSI and 10 KSI, one gate design for 15 KSI and 20 KSI.

In addition, the stems can be standardized to be only Inconel and 4140 steel. Considering stem weight and wall thickness design factor, the stem geometry can be combined for the following valve sizes and pressure ratings: 1) 2″: one stem design for 5 KSI, 10 KSI, 15 KSI, and 20 KSI applications; 2) 3″: one stem design for 5 KSI, 10 KSI, 15 KSI, and 20 KSI applications; 3) 4″: one stem design for 5 KSI and 10 KSI, one stem design for 15 KSI and 20 KSI; 4) 5″: one stem design for 5 KSI and 10 KSI, one stem design for 15 KSI and 20 KSI;

By standardizing parts based on temperature rating, material classes, PSL levels, bolting requirements, overlay, models, indicator type, and seat skirt as described hereinabove, the present invention is able to reduce the number of possible combinations for a gate valve from over 38,000,000,000 to under 17,000,000-over a 2,000 factor reduction in possible combinations. This reduces engineering costs required to build each valve for specific applications and even allows the ability to keep the valves in stock. This makes making delivery much faster.

Accordingly, gate valve 100 utilizes a rectangular lower body cavity 38. The upper body cavity 28 may be round or generally circular. Seats 70 are narrow and may be quite smaller in width than gate 20. Non-elastomeric U-shaped seals provide bidirectional upstream sealing with downstream backup sealing. Skirt 60 prevents debris from entering the body cavity 16.

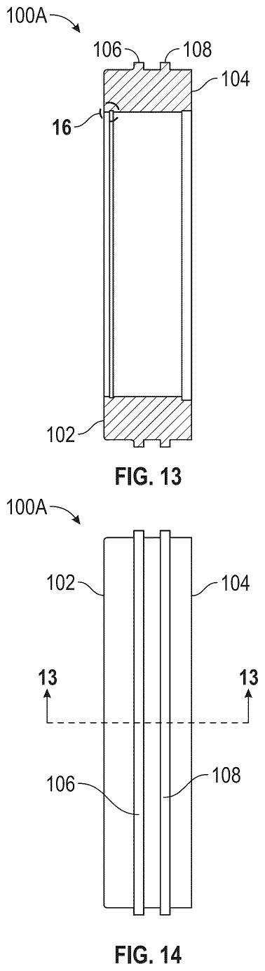

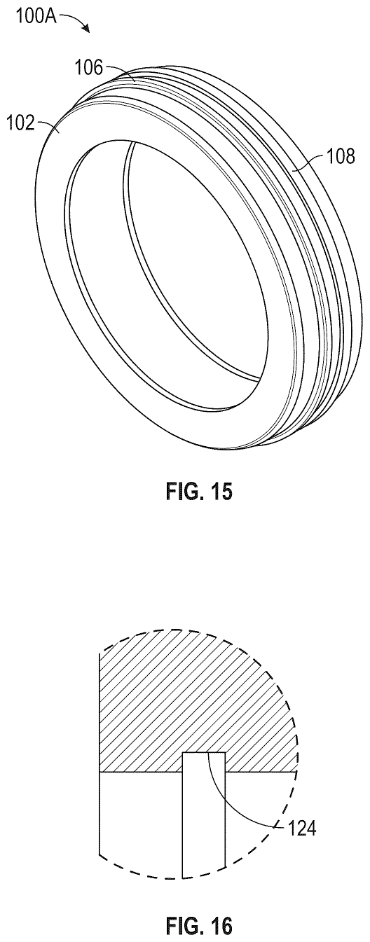

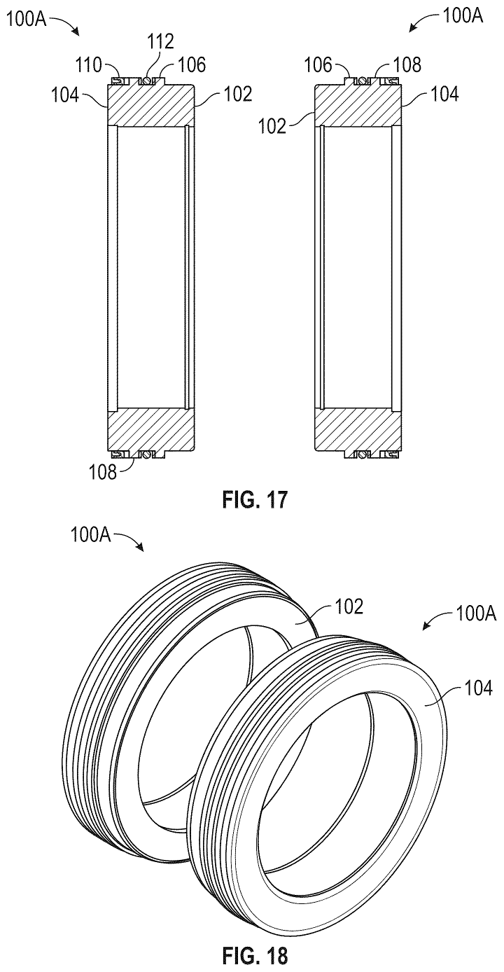

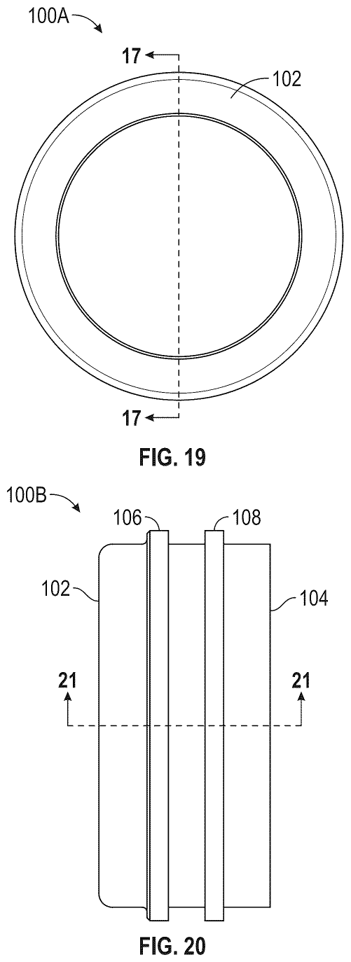

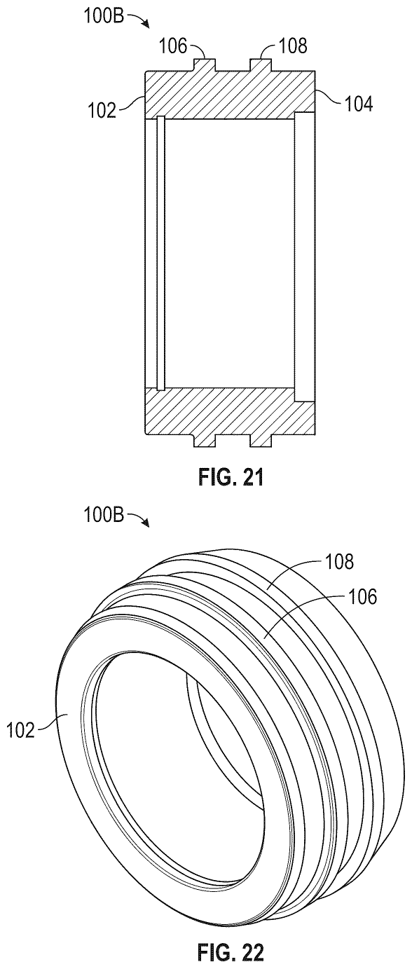

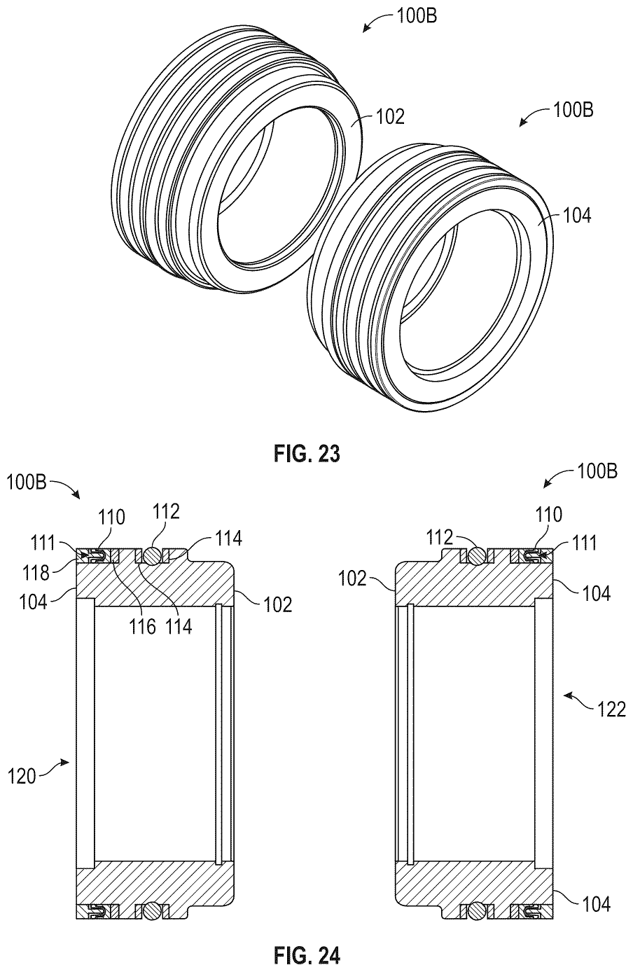

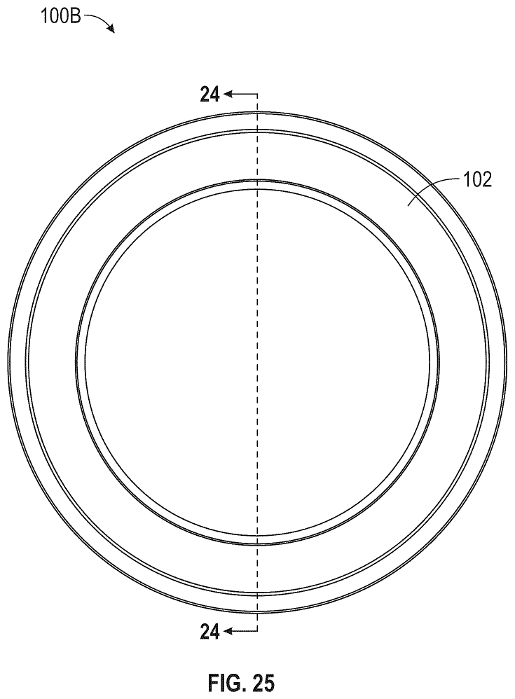

FIGS. 13, 14, 15, 17, 18, and 19 illustrate seats 100A designed for a 7/16-inch gate valve. FIGS. 20, 21, 22, 23, 24, and 25 depict seats 100B for a 3 1/16-inch gate valve rated for 20K psi. While the seats 100A and 100B are conceptually similar, their shapes differ slightly due to size variations. Both seat types can be used in the appropriately sized gate valves previously discussed or in other gate valves as needed and perform the function of seats 70, discussed previously.

The sealing surface end 102, visible in most of the figures, is designed to create a metal-to-metal seal with the gate 20. The pocket end 104 is configured to fit into the pocket 32 of the gate valve body 18.

Each seat 100A or 100B features two radially extending flanges, 106 and 108, located in a generally central region. In one embodiment, the seats and flanges are of monolithic (one-piece) construction, meaning they are machined as a single unit with no joints, ensuring continuous metal material throughout. In an alternative embodiment, the flanges could be formed as two interfitting pieces seated within corresponding grooves in the seats (not shown).

FIGS. 13 and 24 depict a seal arrangement that achieves a highly reliable triple-seal configuration.

The unidirectional seal 110 is a U-shaped seal with its opening 111 facing the pocket end 104 of the seat, away from the gate or metal-to-metal seal end 102. This seal is termed “unidirectional” because it seals against fluid pressure in only one direction. Fluid pressure entering the opening 111 forces the wings of the U-shaped seal to expand, creating a dynamic fluid-tight seal against the pocket of the gate valve body. As fluid pressure increases, the wings press harder against the pocket surface, enhancing the seal. This pressure direction is generally indicated by arrow 120, which may be upstream pressure.

The U-shaped seals 110 may include spring rings (not shown) and may further include a hat ring 118 that encourages the spring rings to expand. These components ensure an initial seal at zero or low pressures. A support or anti-extrusion ring 116 may be positioned on the side opposite the opening. The seal 110 is secured in place by flange 106 and the pocket surface of the valve body. In this design, only one unidirectional seal 110 is used per seat.

The bidirectional seal 112, typically an O-ring, is mounted between flanges 106 and 108. Support or anti-extrusion rings 114 may be placed on either side of the bidirectional seal. This seal is termed “bidirectional” because it can withstand fluid pressure from either direction, as indicated by arrows 120 or 122, corresponding to fluid pressure in the connected pipe, such as upstream and downstream fluid pressure. O-rings, made of elastomeric material, are sized to press against the pocket surface when installed, creating an initial seal. As pressure increases, the O-ring material deforms to maintain the seal. In this embodiment, only one bidirectional seal 112 is used per seat.

The combination of a unidirectional seal and a bidirectional seal on the seat forms a hybrid seal arrangement. This design reduces the required seat length compared to using additional seals, though additional seals could be added to create a quadruple seal or similar configuration. The hybrid seal arrangement, which is the same on both seats, enables the gate valve to be reversible, allowing it to be installed in either orientation when connected to pipes.

During operation, upstream pressure (indicated by arrow 120) first encounters the unidirectional seal 110. If the gate is closed, the metal-to-metal seal prevents fluid from flowing past the gate. The unidirectional seal 110 blocks any potential leakage around the metal-to-metal seal flowing between the pocket walls and the seat. Accordingly, this seal is a first seal encountered by fluid pressure. While unidirectional seals are highly reliable, leaks are still possible.

Any pressure that bypasses the unidirectional seal 110, or first seal, on the upstream seat is contained by the bidirectional seal 112, which forms a second seal. Although O-ring seals are generally reliable, leaks can occur. In such cases, pressure would travel through the valve body cavity between the bonnet and gate valve body until it reaches the bidirectional seal 112 on the downstream seat, which forms a third seal. This hybrid seal arrangement ensures that upstream pressure encounters three seals, creating a robust triple-seal configuration.

Internal grooves, for example, groove 124 may also be formed on the seats 100A, 100B if desired as indicated in FIG. 16.

The foregoing disclosure and description of the invention is illustrative and explanatory thereof, and it will be appreciated by those skilled in the art that various changes in the size, shape and materials as well as in the details of the illustrated construction or combinations of features of the various elements may be made without departing from the spirit of the invention. Moreover, the scope of this patent is not limited to its literal terms but instead embraces all equivalents to the claims described.

1. A method to provide triple seals in a gate valve with a throughbore comprising:
providing a gate within said gate valve that is movable between a closed position wherein said gate is positioned to block fluid flow through said throughbore and an open position wherein said gate is positioned to allow fluid flow through said throughbore;
providing an upstream seat and a downstream seat;
providing a pocket end and a metal-to-metal gate seal end on each of said upstream seat and said downstream seat;
providing a first outwardly extending flange and a second outwardly extending flange on each of said upstream seat and said downstream seat, said first outwardly extending flange being closer to said pocket end than said second outwardly extending flange on each of said upstream seat and said downstream seat;
mounting only one unidirectional seal on each of said upstream seat and said downstream seat between said first outwardly extending flange and said pocket end;
mounting only one bidirectional seal on each of said upstream seat and said downstream seat between said first outwardly extending flange and said second outwardly extending flange on each of said upstream seat and said downstream seat; and
wherein, when said gate is in said closed position, said unidirectional seal on said upstream seat provides a first seal to an upstream pressure, said bidirectional seal on said upstream seat provides a second seal to said upstream pressure when said first seal leaks, said bidirectional seal on said downstream seat provides a third seal to said upstream pressure when said first seal and said second seal leaks.

2. The method of claim 1 comprising providing a gate valve body and a bonnet mounted to said gate valve body, said bonnet defining a bonnet cavity therein, said third seal to said upstream pressure receives said upstream pressure through said bonnet cavity when said first seal and said second seal leak.

3. The method of claim 1 comprising orienting an opening on said unidirectional seal on each of said upstream seat and said downstream seat toward said pocket end on each of said upstream seat and said downstream seat.

4. The method of claim 1 wherein said gate valve is reversible.

5. The method of claim 1 comprising providing that said first outwardly extending flange and said second outwardly extending flange on said upstream seat are of monolithic construction and first outwardly extending flange and said second outwardly extending flange on said downstream seat are of monolithic construction.

6. The method of claim 1 comprising said unidirectional seal on each of said upstream seat and said downstream seat comprising a U-shaped seal with an opening of said U-shaped seal oriented away from said gate.

7. The method of claim 6 comprising a hat ring that extends into said opening on said unidirectional seal on each of said upstream seat and said downstream seat.

8. The method of claim 7 comprising a support ring on a side opposite said opening of said unidirectional seal on each of said upstream seat and said downstream seat.

9. The method of claim 8 comprising a support ring positioned on opposite sides said of said bidirectional seal on each of said upstream seat and said downstream seat.

10. A gate valve assembly comprising:
a valve body defining a throughbore;
a gate movable within said valve body between an open position and a closed position; and an upstream seat and a downstream seat, each seat positioned between said gate and said valve body, wherein each seat comprises:
a metal seat body, a first outwardly extending flange and a second outwardly extending flange;
a single unidirectional seal positioned between said first outwardly extending flange and a pocket end of said seat, said unidirectional seal having an opening oriented away from said gate;
a single bidirectional seal positioned between said first outwardly extending flange and said second outwardly extending flange; and
wherein, when said gate is in said closed position, said unidirectional seal on said upstream seat provides a primary seal against an upstream fluid pressure, said bidirectional seal on said upstream seat provides a secondary seal against said upstream fluid pressure if said primary seal leaks, and said bidirectional seal on said downstream seat provides a tertiary seal against said upstream fluid pressure if said primary seal and secondary seal leak.

11. The gate valve assembly of claim 10, wherein said valve body comprises a rectangular lower body cavity sized to securely receive said gate.

12. The gate valve assembly of claim 11, wherein said valve body further comprises a generally circular upper body cavity positioned above a rectangular lower body cavity.

13. The gate valve assembly of claim 10, further comprising a skirt assembly disposed within said valve body, said skirt assembly configured to cover an opening of said gate when said gate is in said closed position to prevent debris from entering a body cavity of said valve body.

14. The gate valve assembly of claim 10, wherein said unidirectional seal and said bidirectional seal are non-elastomeric seals.

15. The gate valve assembly of claim 14, wherein said non-elastomeric seals comprise PTFE seals with stainless steel springs.

16. The gate valve assembly of claim 10, wherein said gate valve is reversible, such that either the upstream seat or the downstream seat can function as the upstream sealing side, providing a triple seal configuration.

17. A gate valve seat assembly for a bidirectional gate valve having a throughbore and a gate movable between an open and a closed position, said gate valve seat assembly comprising:
a metal seat body having a metal-to-metal gate seal end and a pocket end;
a first outwardly extending flange and a second outwardly extending flange radially extending from said metal seat body;
a single unidirectional seal positioned between said first outwardly extending flange and said pocket end, wherein an opening of said unidirectional seal is oriented towards said pocket end;
a single bidirectional seal positioned between said first outwardly extending flange and said second outwardly extending flange; and
wherein the combination of said unidirectional seal and said bidirectional seal on said seat forms a hybrid seal arrangement configured to provide a triple seal against fluid pressure when combined with a complementary seat assembly in a gate valve, regardless of the gate valve's installation orientation.

18. The gate valve seat assembly of claim 17, wherein said unidirectional seal comprises a U-shaped seal.

19. The gate valve seat assembly of claim 17, wherein said bidirectional seal comprises an O-ring.

20. The gate valve assembly of claim 10, wherein said first outwardly extending flange and said second outwardly extending flange radially extending from said metal seat body are machined to be of one-piece construction out of Inconel metal.
